(19) United States
(12) Patent Application Publication
(10) Pub. No.: US 2012/0232181 A1
(43) Pub. Date: Sep. 13, 2012

(54) CATALYSTS AND THEIR USE

(75) Inventors: Stephan Reiter, Langenfeld (DE); Jens Krause, Leverkusen (DE); Harald Knaup, Neuss (DE); Klaus Jurkschat, Dortmund (DE); Markus Schürmann, Recklinghausen (DE); Gerrit Bradtmöller, Dorsten (DE)

(73) Assignee: Bayer MaterialScience Ag, Leverkusen (DE)

(21) Appl. No.: 13/503,764

(22) PCT Filed: Oct. 26, 2010
(86) PCT No.: PCT/EP2010/066102

§ 371 Date: May 29, 2012

(30) Foreign Application Priority Data
Oct. 28, 2009 (DE) 102009051014.1

(51) Int. Cl. C07F 7/28; C08G 18/22; C08L 75/04; C08G 18/76; C08J 9/04

(52) U.S. Cl. 521/170; 528/52; 524/590; 556/56

(57) ABSTRACT

The invention relates to novel catalysts and the use thereof, for example in the preparation of polyisocyanate polyaddition products.

The invention relates to novel catalysts and the use thereof, for example in the preparation of polyisocyanate polyaddition products.

Polyurethanes have been known for a long time and are employed in many fields. The actual polyurethane reaction must often be carried out using catalysts, since otherwise the reaction proceeds too slowly and may lead to polyurethane products with poor mechanical properties. In most cases the reaction between the hydroxyl component and the NCO component must be catalysed. Among the usual catalysts, a distinction is made between metal-containing catalysts and catalysts which do not contain metal. Typical usual catalysts are, for example, amine catalysts, such as, for example, 1,8-diazabicyclo[5.4.0]undec-7-ene (DBU), 1,4-diazabicyclo[2.2.2]octane (DABCO) or triethanolamine. Metal-containing catalysts are usually Lewis acid compounds, such as, for example, dibutyltin dilaurate, lead octoate, tin octoate, complexes of titanium and zirconium, but also compounds of cadmium, bismuth (for example bismuth neodecanoate) and iron. One requirement of the catalyst is that it catalyses only one of the diverse polyurethane reactions, such as, for example, only the reaction between OH and NCO groups. Side reactions, such as e.g. di- or trimerizations of the isocyanate, allophanatizations, biuretizations, water reactions or urea formations should not be catalysed by this means. The requirement always comes down to the fact that an optimum catalyst catalyses exactly the reaction which is precisely desired, for example only the water reaction, so that a defined foam profile is formed, or such as, if potassium acetates are used, preferably the polyisocyanurate reaction. To date, however, there are hardly any catalysts which catalyse only a defined reaction. This is precisely extremely desirable, however, given the diverse possible reactions in the preparation of polyurethane. Not only catalysts which catalyse only one reaction in a defined manner, but catalysts which are additionally activated in a targeted manner and catalyse reactions only under certain conditions are of particular interest. Switchable catalysts are referred to in such cases. These switchable catalysts are in turn classified into those which can be switched thermally, photochemically or optically. Latent catalysts are generally also referred to here, and in the thermal case thermolatent catalysts. These catalysts remain dormant until the reaction mixture reaches a certain temperature. Above this temperature they are then active, preferably suddenly active. These latent catalysts render possible long pot lives and short demolding times.

The latent catalysts which are known to date and are preferably employed are mercury compounds. The most prominent representative here is phenylmercury neodecanoate (Thorcat® 535 and Cocure® 44). This catalyst displays a latent reaction profile, the catalyst being initially virtually inactive and becoming suddenly active at a certain temperature (usually about 70° C.) only after slow heating of the mixture, usually due to the exothermicity of the non-catalysed reaction of NCO groups with OH groups. Very long open times with very short curing times can be achieved by employing this catalyst. This is particularly advantageous if a very large amount of material has to be discharged (e.g. a large mould has to be filled), and the reaction is to be ended rapidly and therefore economically after the discharge has taken place.

If latent catalysts are employed, it is particularly advantageous if the following conditions are furthermore met:
a) An increase in the amount of catalyst accelerates the reaction without the catalyst losing the latency.
b) A lowering of the amount of catalyst slows down the reaction without the catalyst losing the latency.
c) A variation in the amount of catalyst, the NCO/OH index, the mixing ratio, the amount ejected and/or the hard segment content in the polyurethane does not impair the latency of the catalyst.
d) In all the abovementioned variations, the catalyst ensures virtually complete reaction of the reactants, without tacky areas remaining.

A particular advantage of the latent catalysts is to be seen in the fact that as a result of their decreasing catalytic action with decreasing temperature, in the finished polyurethane material they accelerate the cleavage of urethane groups, e.g. at room temperature, only little compared with conventional catalysts. They therefore contribute towards favourable long-term use properties of the polyurethanes.

When catalysts are employed, it is moreover generally to be ensured that as far as possible the physical properties of the products are not adversely influenced. This is also the reason why targeted catalysis of a particular reaction is so important. Precisely in the preparation of elastomers, in particular cast elastomers, the use of mercury catalysts is very widespread, since they can be widely employed, do not have to be combined with additional catalysts and catalyse the reaction between OH groups and NCO groups in a very targeted manner. The only—but in return very significant—disadvantage is the high toxicity of mercury compounds, so that great efforts are being made to find alternatives to mercury catalysts. These compounds moreover are undesirable in some industries (automobile, electrical industry).

Systems which are at least less toxic than mercury catalysts, e.g. based on tin, zinc, bismuth, titanium or zirconium, but also amidine and amine catalysts, are indeed known in the market, but so far do not show the robustness and simplicity of the mercury compounds and furthermore are not latent or not latent enough.

WO 2008/018601 describes the use of catalysts which are based on mixtures of amines, cyclic nitrogen compounds, carboxylates and/or quaternary ammonium salts. However, such mixtures have the disadvantages known to the person skilled in the art. While amines and cyclic nitrogen compounds have a directly activating action and therefore are accompanied by a latency which is not sufficient for certain uses, carboxylates and quaternary ammonium salts e.g. also catalyse the polyisocyanurate reaction, which must be absolutely ruled out for certain uses, e.g. high performance elastomers.

Certain combinations of catalysts have the effect that the gel reaction takes place to the greatest extent separately from the curing reaction, since many of these catalysts act only selectively. For example, bismuth(III) neodecanoate is combined with zinc neodecanoate and neodecanoic acid. 1,8-Diazabicyclo[5.4.0]undec-7-ene is often also additionally added. Although this combination is one of the best-known, unfortunately it cannot be employed so widely and universally as e.g. Thorcat® 535 (Thor Especialidades S.A.) and moreover is sensitive to variations in the recipe. The use of these catalysts is described in DE-A 10 2004 011 348. Further combinations of catalysts are disclosed in U.S. Pat. No. 3,714,077, U.S. Pat. No. 4,584,362, U.S. Pat. No. 5,011,902, U.S. Pat. No. 5,902,835 and U.S. Pat. No. 6,590,057.

The combination of titanium and zirconium catalysts with bismuth catalysts is described. In WO 2005/058996. A decisive disadvantage of the catalyst combinations described, however, is that they cannot be employed so widely and universally as the mercury catalysts and are sensitive to variations in the recipe.

The titanium catalysts described in WO 2008/155569 also have some disadvantages compared with the mercury catalysts. The addition of an amine-based co-catalyst is necessary for acceptable results. This is a trimerization catalyst, which in certain uses (e.g. cast elastomers) has adverse effects on the physical properties of the polyurethanes. By varying the mixing ratio of the catalyst components, either a very good latency or very good material properties can be achieved, but not both at the same time. The catalyst combinations described must consequently be matched to the particular requirements with respect to their mixing ratio, i.e. not all uses can be covered with one catalyst combination, which is a decisive disadvantage.

The product DABCO DC-2 obtainable in the market from Air Products Chemicals Europe B.V. is a catalyst mixture of 1,4-diazabicyclo[2.2.2]octane (DABCO) and dibutyltin diacetate. The disadvantage of this mixture is that the amine has a directly activating action. Alternative systems are, for example, POLYCAT® SA-1/10 (Air Products Chemicals Europe B.V.). This is DABCO blocked with acid. Although this system is thermolatent, such systems are not used in curing because of their poor catalytic action; the elastomers prepared in the presence of these systems remain tacky at the end of the reaction; “starving” of the reaction is also referred to.

WO 2009/050115 describes photolatent catalysts, which nevertheless have several significant disadvantages. Solid mouldings are as a rule produced in non-transparent metal moulds, as a result of which activation of the photolatent catalysts by an external source of radiation is practically impossible. Even in the event of a technical solution to this problem, a further inherent disadvantage emerges from the limited depth of penetration of the electromagnetic radiation into the reaction mixture.

The object was therefore to provide systems and catalysts with which it is possible to prepare polyisocyanate polyaddition products with good mechanical properties, and which initially provide a severely delayed and after this initial phase an accelerated reaction to give the end product. The system and the catalyst should furthermore be free from toxic heavy metals, such as cadmium, mercury and lead.

It has been possible to achieve this object, surprisingly, by the use of specific metal catalysts (titanium, zirconium and hafnium catalysts).

The invention provides polyisocyanate polyaddition products with good mechanical properties, which are obtainable from
a) polyisocyanates and
b) NCO-reactive compounds
in the presence of
c) latent catalysts
d) optionally further catalysts and/or activators which differ from c)
with the addition of
e) optionally blowing agents
f) optionally fillers and/or fibre materials
g) optionally auxiliary substances and/or additives,
characterized in that tetravalent mononuclear titanium, zirconium and/or hafnium compounds of the formula I having at least one ligand which is bonded via at least two oxygen or sulfur atoms and contains a single nitrogen atom

Me(IV)(L¹)ₙ₁(L²)ₙ₂(L³)ₙ₃ (I)
where n1 is 1 or 2, n2 and n3 are 0 or 1, Me is Ti, Zr or Hf and L¹ is a di-, tri- or tetravalent ligand and L², L³ are mono- or divalent ligands
or tetravalent polynuclear titanium, zirconium and/or hafnium compounds based thereon are employed as latent catalysts, wherein at least one ligand per Me atom has the following meaning:

—X—Y
where X═O, S, OC(O), OC(S), O(O)S(O)O, O(O)S(O)
   Y═—R1-N(R2)(R3) or —R1-C(R4)=NR2
R1, R2, R3, R4 independently of each other are saturated or unsaturated, cyclic or acyclic, branched or unbranched, substituted or unsubstituted hydrocarbon moieties which optionally contain hetero atoms, or R2, R3, R4 independently of each other are hydrogen, R1-X, or R2 and R3 or R2 and R1 or R3 and R1 or R4 and R1 or R4 and R2 form a ring
and —X—Y is bonded to an Me atom by at least two oxygen or sulfur atoms
and wherein the remaining ligands independently of each other are —X—Y with the abovementioned meaning or have the following meaning:
   halides, hydroxide, amide moieties, oxygen, sulfur or XR2, particularly preferably alcoholates or carboxylates.

In this application, the expression “a ligand containing a single nitrogen atom” means ligands with one nitrogen atom and ligands which contain two nitrogen atoms bonded directly to one another. Ligands with one nitrogen atom are preferred.

The invention also provides a process for the preparation of the polyisocyanate polyaddition products according to the invention, wherein
polyisocyanates (a) are reacted with NCO-reactive compounds (b) in the presence of latent catalysts (c) and optionally additional catalysts and/or activators which differ from (c), with the addition of optionally blowing agents, optionally fillers and/or fibre materials and optionally auxiliary substances and/or additives, characterized in that tetravalent mononuclear titanium, zirconium and/or hafnium compounds of the formula I having at least one ligand which is bonded via at least two oxygen or sulfur atoms and contains a single nitrogen atom

Me(IV)(L¹)ₙ₁(L²)ₙ₂(L³)ₙ₃ (I)
where n1 is 1 or 2, n2 and n3 are 0 or 1, Me is Ti, Zr or Hf and L¹ is a di-, tri- or tetravalent ligand and L², L³ are mono- or divalent ligands
or tetravalent polynuclear titanium, zirconium and/or hafnium compounds based thereon are employed as latent catalysts (c), wherein at least one ligand per Me atom has the following meaning:

—X—Y
where X═O, S, OC(O), OC(S), O(O)S(O)O, O(O)S(O)
   Y═—R1-N(R2)(R3) or —R1-C(R4)=NR2
R1, R2, R3, R4 independently of each other are saturated or unsaturated, cyclic or acyclic, branched or unbranched, substituted or unsubstituted hydrocarbon moieties which optionally contain hetero atoms, or R2, R3, R4 independently of each other are hydrogen, R1-X, or R2 and R3 or R2 and R1 or R3 and R1 or R4 and R1 or R4 and R2 form a ring
and —X—Y is bonded to an Me atom by at least two oxygen or sulfur atoms
and wherein the remaining ligands independently of each other are —X—Y with the abovementioned meaning or have the following meaning:
   halides, hydroxide, amide moieties, oxygen, sulfur or XR2, particularly preferably alcoholates or carboxylates.

The invention also provides latent catalysts comprising tetravalent mononuclear titanium, zirconium and/or hafnium compounds of the formula I having at least one ligand which is bonded via at least two oxygen or sulfur atoms and contains a single nitrogen atom, or di- or polynuclear tetravalent titanium, zirconium and/or hafnium compounds of the formulae II, III or IV having at least one ligand per metal (Me) atom which is bonded via at least two oxygen or sulfur atoms and contains a single nitrogen atom

Me(IV)(L¹)ₙ₁(L²)ₙ₂(L³)ₙ₃ (I)
where n1 is 1 or 2 and n2 and n3 are 0 or 1, Me is Ti, Zr or Hf and L¹ is a di-, tri- or tetravalent ligand and L², L³ are mono- or divalent ligands

[(L¹)ₙ₁(L²)ₙ₂Me(IV)]₂O (II)
where n1 is 1 and n2 is 0 or 1, Me is Ti, Zr or Hf and L¹ is a di- or trivalent ligand and L² is a monovalent ligand

[(L¹)ₙ₁Me(IV)O]ₙ (III)

[(L¹)ₙ₁Me(IV)S]ₙ (IV)
where n1 is 1, n is greater than or equal to 2, Me is Ti, Zr or Hf and L¹ is a divalent ligand,
wherein at least one ligand per Me atom has the following meaning:

—X—Y
where X═O, S, OC(O), OC(S), O(O)S(O)O, O(O)S(O)
   Y═—R1-N(R2)(R3) or —R1-C(R4)=NR2
R1, R2, R3, R4 independently of each other are saturated or unsaturated, cyclic or acyclic, branched or unbranched, substituted or unsubstituted hydrocarbon moieties which optionally contain hetero atoms, or R2, R3, R4 independently of each other are hydrogen, R1-X, or R2 and R3 or R2 and R1 or R3 and R1 or R4 and R1 or R4 and R2 form a ring
and —X—Y is bonded to an Me atom by at least two oxygen or sulfur atoms
and wherein the remaining ligands independently of each other are —X—Y with the abovementioned meaning or have the following meaning:
   halides, hydroxide, amide moieties, oxygen, sulfur or XR2, particularly preferably alcoholates or carboxylates.

The compounds employed as latent catalysts are known in the literature. Processes for the preparation of the compounds are to be found, inter alia, in: T. Kemmitt, N. I. Al-Salim, G. J. Gainsford, W. Henderson, Aust. J. Chem. 1999, 52, 915; K. V. Zaitsev, S. S. Karlov, A. A. Selina, Yu. F. Oprunenko, A. V. Churakov, B. Neumüller, J. A. K. Howard, G. S. Zaitseva, Eur. J. Inorg. Chem. 2006, 1987; M. K. Sharma, A. Singh, R. C. Mehrotra, Indian J. Chem. 2001, 40A, 568; K. V. Zaitsev, M. V. Bermeshev, A. A. Samsonov, J. F. Oprunenko, A. V. Churakov, J. A. L. Howard, S. S. Karlov, G. S. Zaitseva, New J. Chem. 2008, 32, 1415; and literature cited therein.

The latent catalysts comprising the abovementioned titanium, zirconium or hafnium(IV) compounds are preferably employed in the preparation of polyisocyanate polyaddition compounds, in particular polyurethanes.

The ligands which differ from the specific ligand are the ligands known from titanium, zirconium and hafnium chemistry. In the present invention these ligands independently of each other are bonded to the titanium, zirconium or hafnium exclusively via non-carbon atoms (inorganic metal compounds). The inorganic metal compounds—that is to say metal compounds without metal-carbon bonds—are preferable to corresponding organometallic compounds because of their lower toxicity.

The ligands which differ from the specific ligand are preferably oxygen bridges, hydroxide, amide moieties, alcoholates, carboxylates, sulfur bridges, thiolates (in each case preferably having 1 to 30 carbon atoms, particularly preferably having 1 to 12 carbon atoms) and halides (preferably chloride and bromide), and the bonding of the ligands to the titanium, zirconium and hafnium is particularly preferably via oxygen, e.g. as an alkoxy group (alcoholate) or as carboxylate.

Preferred alcoholate ligands are MeO—, EtO—, PrO—, iPrO—, BuO—, tBuO—, PhO— and:

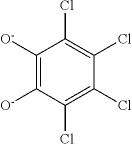

Me=methyl, Et=ethyl, Pr=propyl, iPr=isopropyl, Bu=n-butyl, tBu=tert-butyl, Ph=phenyl moiety.

Preferred carboxylate ligands are formate, acetate, propanoate, butanoate, pentanoate, hexanoate, ethylhexanoate, laurate, lactate and benzoate, particularly preferably ethylhexanoate, laurate and benzoate.

The titanium, zirconium and hafnium compounds—as is generally known—tend towards oligomerization, so that polynuclear metal compounds or mixtures of mono- and polynuclear metal compounds are often present. In the polynuclear metal compounds, the metal atoms are preferably bonded to one another via oxygen atoms.

Typical oligomeric complexes (polynuclear metal compounds) are formed e.g. by a condensation reaction of the metal atoms via oxygen or sulfur, e.g. [OMe(O—R1-N(R2)-R1-O)]ₙ, where n is >1. At low degrees of oligomerization cyclic and at higher degrees of oligomerization linear oligomers with OH end groups are found.

In the specific ligand —X—Y, X preferably denotes oxygen, sulfur or —O—C(O)—.

The ligand —X—Y is preferably a ligand in which X is sulfur or oxygen and Y is —CH₂CH₂N(R)CH₂CH₂S or —CH₂CH₂N(R)CH₂CH₂O, where R is preferably Me, Et, Bu, tBu, Pr, iPr or Ph.

The ligand —X—Y is preferably a ligand in which X is —O—C(O)— and Y is —CH₂—N(R)CH₂C(O)O, where R is preferably Me, Et, Bu, tBu, Pr, iPr or Ph.

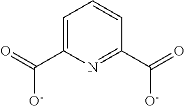

is also preferred as the specific ligand.

Preferred specific ligands —X—Y are:

HN[CH₂CH₂O—]₂, —OCH₂CH₂N(H)CH₂CH₂CH₂O—, HN[CH₂CH(Me)O—]₂, MeN[CH₂CH₂O—]₂, BuN[CH₂CH₂O—]₂, PhN[CH₂CH₂O—]₂, MeN[CH₂CH(Me)O—]₂, BuN[CH₂CH(Me)O—]₂, PhN[CH₂CH(Me)O—]₂

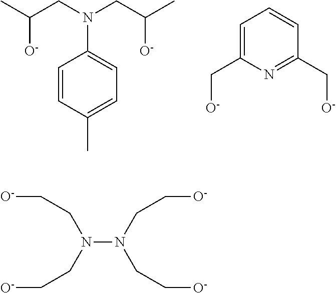

In a preferred variant, the metal compound is

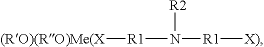

where X═O, S, OC(O), preferably O and OC(O), particularly preferably O, wherein the moieties R′ and R″ can be identical or different. The moieties R1 can be different or identical and have the abovementioned meaning. The moiety R2 has the abovementioned meaning. In a particularly preferred embodiment, the moieties R′ and R″ are identical, as are also the two moieties R1. The moieties R′ and R″ and R2 are preferably alkyl moieties. The moieties R1 are preferably —(CH₂)ₙ—, wherein n is preferably 2. R2 and R′ and R″ are preferably methyl, butyl, propyl or isopropyl. Oxygen atoms can also stand in place of the moieties R′O and R″O, a dinuclear metal compound bonded via two oxygen bridges then being obtained. This is a special case of the oligomeric Me(IV) compounds described, [OMe(O—R1-N(R2)-R1-O)ₙ where n is >1.

Of the titanium, zirconium and hafnium catalysts, the titanium and zirconium catalysts are preferred, and the titanium catalysts are particularly preferred.

In the cases where the metal compounds contain ligands with free OH groups, the catalyst may be chemically linked to the product in the polyisocyanate polyaddition reaction. Linkage can also take place via free NH or NH₂ groups of the ligands. A particular advantage of these catalysts which can be linked to the polyurethane is their greatly reduced fogging behaviour, which is important especially in the use of polyurethanes in automobile interiors.

The following formulae Ia to Ij illustrate some embodiment examples of the latent catalysts employed.

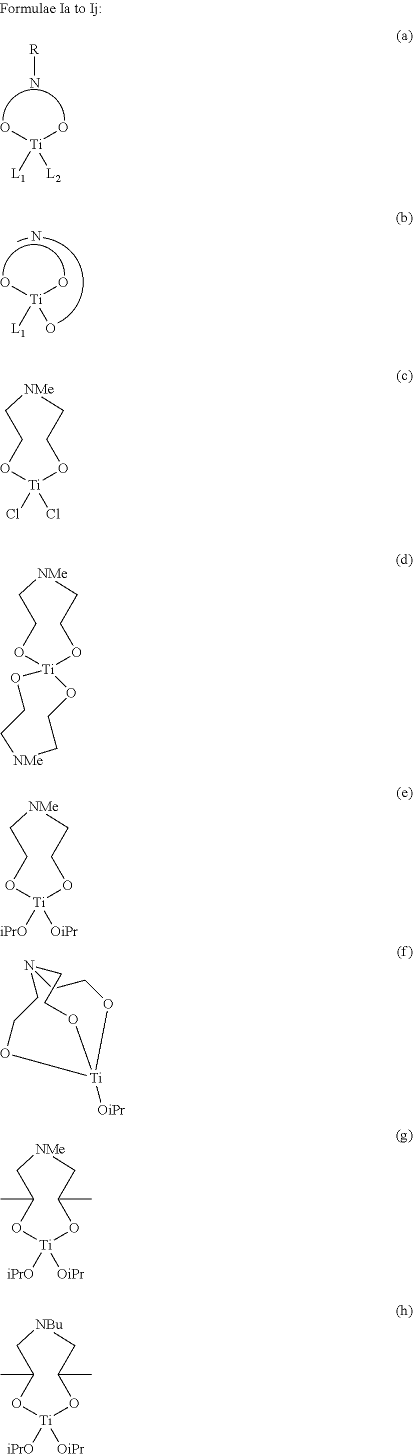

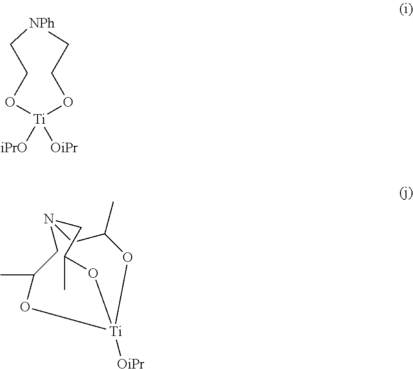

The formulae Ik and Il show oligomerized (e.g. dimerized) compounds. An advantage of these oligomeric substances is their greatly reduced vapour pressure. This leads to low fogging values in the polyurethanes e.g. prepared with these compounds. Low fogging values are very important in particular in the use of the polyurethanes in the automobile industry.

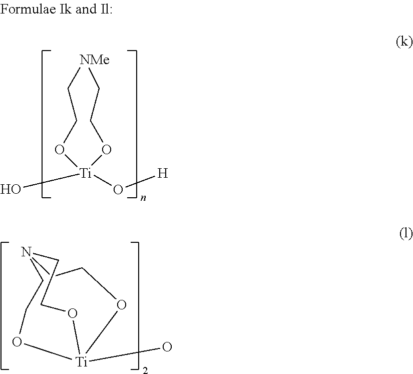

In the dissolved form, the ligands on the metal can be exchanged with one another or with the solvent (coordinating solvent) and form further, alternative bridged or condensed structures with a higher or deviating metal nucleus content, as is known from titanium, zirconium and hafnium chemistry. This is a dynamic equilibrium.

The latent catalysts can be combined with further catalysts/activators known from the prior art; for example titanium-, zirconium-, bismuth-, tin- and/or iron-containing catalysts such as are described, for example, in WO 2005/058996.

An addition of amines or amidines is also possible. Acidic compounds, such as e.g. 2-ethylhexanoic acid, or alcohols can moreover be added in the polyisocyanate polyaddition reaction to control the reaction.

In a preferred variant, the latent catalyst is added to the reaction mixture via the NCO-reactive compound or in a solvent. Metering in via the isocyanate component is also conceivable.

The polyisocyanates (a) which are suitable for the preparation of polyisocyanate polyaddition compounds, in particular polyurethanes, are the organic aliphatic, cycloaliphatic, aromatic or heterocyclic polyisocyanates which are known per se to the person skilled in the art and have at least two isocyanate groups per molecule, and mixtures thereof. Examples of suitable aliphatic or cycloaliphatic polyisocyanates are di- or triisocyanates, such as butane-diisocyanate, pentane-diisocyanate, hexane-diisocyanate (hexamethylene-diisocyanate, HDI), 4-isocyanatomethyl-1,8-octane-diisocyanate (triisocyanatononane, TIN) and cyclic systems, such as e.g. 4,4′-methylene-bis(cyclohexyl-isocyanate), 3,5,5 -trimethyl-1 -isocyanato-3 -isocyanatomethylcyclohexane (iso-phorone-diisocyanate, IPDI) and ω,ω′-diisocyanato-1,3-dimethylcyclohexane (H₆XDI). Aromatic polyisocyanates which can be employed are e.g. 1,5-naphthalene-diisocyanate, diisocyanatodi-phenylmethane (2,2′-, 2,4′- and 4,4′-MDI or mixtures thereof), diisocyanatomethylbenzene (2,4- and 2,6-toluylene-diisocyanate, TDI) and technical grade mixtures of the two isomers, and 1,3-bis(isocyanatomethyl)benzene (XDI). TODI (3,3′-dimethyl-4,4′-biphenyl-diisocyanate), PPDI (1,4-paraphenylene-diisocyanate) and CHDI (cyclohexyl-diisocyanate) can furthermore be used.

However, the secondary products, which are known per se, of the abovementioned organic aliphatic, cycloaliphatic, aromatic or heterocyclic polyisocyanates having a carbodiimide, uretonimine, uretdione, allophanate, biuret and/or isocyanurate structure and prepolymers which are obtained by reaction of the polyisocyanate with compounds having groups which are reactive towards isocyanate groups can moreover also be employed.

The polyisocyanate component (a) can be present in a suitable solvent. Suitable solvents are those which have an adequate solubility of the polyisocyanate component and are free from groups which are reactive towards isocyanates. Examples of such solvents are acetone, methyl ethyl ketone, cyclohexanone, methyl isobutyl ketone, methyl isoamyl ketone, diisobutyl ketone, ethyl acetate, n-butyl acetate, ethylene glycol diacetate, butyrolactone, diethyl carbonate, propylene carbonate, ethylene carbonate, N,N-dimethylformamide, N,N-dimethylacetamide, N-methylpyrrolidone, N-ethylpyrrolidone, methylal, ethylal, butylal, 1,3-dioxolane, glycerol formal, benzene, toluene, n-hexane, cyclohexane, solvent naphtha and 2-methoxypropyl acetate (MPA).

The isocyanate component can moreover contain conventional auxiliary substances and additives, such as e.g. rheology improvers (for example ethylene carbonate, propylene carbonate, dibasic esters, citric acid esters), stabilizers (for example Brønstedt and Lewis acids, such as, for example, hydrochloric acid, phosphoric acid, benzoyl chloride, organomineral acids, such as dibutyl phosphate, furthermore adipic acid, malic acid, succinic acid, pyruvic acid or citric acid), UV stabilizers (for example 2,6-dibutyl-4-methylphenol), hydrolysis stabilizers, for example sterically hindered carbodiimides), emulsifiers and catalysts (for example trialkylamines, diazabicyclooctane, tin dioctoate, dibutyltin dilaurate, N-alkylmorpholine, lead octoate, zinc octoate, tin octoate, calcium octoate, magnesium octoate, the corresponding naphthenates and p-nitrophenolate and/or also phenylmercury neodecanoate) and fillers (for example chalk), optionally dyestuffs which can be incorporated into the polyurethane/polyurea to be formed later (that is to say dyestuffs which have Zerewitinoff-active hydrogen atoms) and/or coloured pigments.

All the compounds known to the person skilled in the art which have an average OH or NH functionality of at least 1.5 can be employed as NCO-reactive compounds (b). These can be, for example, low molecular weight diols (e.g. 1,2-ethanediol, 1,3- and 1,2-propanediol, 1,4-butanediol), triols (e.g. glycerol, trimethylolpropane) and tetraols (e.g. pentaerythritol), short-chain polyamines, but also higher molecular weight polyhydroxy compounds, such as polyether polyols, polyester polyols, polycarbonate polyols, polysiloxane polyols, polyamines and polyether-polyamines, as well as polybutadiene polyols.

Polyether polyols are accessible in a manner known per se by alkoxylation of suitable starter molecules under base catalysis or with the use of double metal cyanide compounds (DMC compounds). Suitable starter molecules for the preparation of polyether polyols are, for example, simple, low molecular weight polyols, water, organic polyamines having at least two N—H bonds or any desired mixtures of such starter molecules. Preferred starter molecules for the preparation of polyether polyols by alkoxylation, in particular by the DMC process, are, in particular, simple polyols, such as ethylene glycol, propylene 1,3-glycol and butane-1,4-diol, hexane-1,6-diol, neopentyl glycol, 2-ethylhexane-1,3-diol, glycerol, trimethylolpropane, pentaerythritol and low molecular weight esters, containing hydroxyl groups, of such polyols with dicarboxylic acids of the type mentioned below by way of example or low molecular weight ethoxylation or propoxylation products of such simple polyols, or any desired mixtures of such modified or non-modified alcohols. Alkylene oxides which are suitable for the alkoxylation are, in particular, ethylene oxide and/or propylene oxide, which can be employed in the alkoxylation in any desired sequence or also in a mixture.

Polyester polyols can be prepared in a known manner by polycondensation of low molecular weight polycarboxylic acid derivatives, such as, for example, succinic acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, trimer fatty acid, phthalic acid, phthalic anhydride, isophthalic acid, terephthalic acid, citric acid or trimellitic acid, with low molecular weight polyols, such as, for example, ethylene glycol, diethylene glycol, neopentyl glycol, hexanediol, butanediol, propylene glycol, glycerol, trimethylolpropane, 1,4-hydroxymethylcyclohexane, 2-methyl-1,3-propanediol, butane-1,2,4-triol, triethylene glycol, tetraethylene glycol, polyethylene glycol, dipropylene glycol, polypropylene glycol, dibutylene glycol and polybutylene glycol, or by ring-opening polymerization of cyclic carboxylic acid esters, such as ε-caprolactone. Hydroxycarboxylic acid derivatives, such as, for example, lactic acid, cinnamic acid or ω-hydroxycaproic acid, can moreover also be subjected to polycondensation to give polyester polyols. However, polyester polyols of oleochemical origin can also be used. Such polyester polyols can be prepared, for example, by complete ring-opening of epoxidized triglycerides of a fatty acid mixture containing at least partly olefinically unsaturated fatty acid with one or more alcohols having 1 to 12 C atoms and subsequent partial transesterification of the triglyceride derivatives to give alkyl ester polyols having 1 to 12 C atoms in the alkyl moiety.

The preparation of suitable polyacrylate polyols is known per se to the person skilled in the art. They are obtained by free radical polymerization of olefinically unsaturated monomers containing hydroxyl groups or by free radical copolymerization of olefinically unsaturated monomers containing hydroxyl groups with optionally other olefinically unsaturated monomers, such as e.g. ethyl acrylate, butyl acrylate, 2-ethylhexyl acrylate, isobornyl acrylate, methyl methacrylate, ethyl methacrylate, butyl methacrylate, cyclohexyl methacrylate, isobornyl methacrylate, styrene, acrylic acid, acrylonitrile and/or methacrylonitrile. Suitable olefinically unsaturated monomers containing hydroxyl groups are, in particular, 2-hydroxyethyl acrylate, 2-hydroxyethyl methacrylate, the hydroxypropyl acrylate isomer mixtures obtainable by addition of propylene oxide on to acrylic acid, and the hydroxypropyl methacrylate isomer mixture obtainable by addition of propylene oxide on to methacrylic acid. Suitable free radical initiators are those from the group of azo compounds, such as, for example, azoisobutyronitrile (AIBN), or from the group of peroxides, such as, for example, di-tert-butyl peroxide.

Component (b) can be present in a suitable solvent. Suitable solvents are those which have an adequate solubility of the component. Examples of such solvents are acetone, methyl ethyl ketone, cyclohexanone, methyl isobutyl ketone, methyl isoamyl ketone, diisobutyl ketone, ethyl acetate, n-butyl acetate, ethylene glycol diacetate, butyrolactone, diethyl carbonate, propylene carbonate, ethylene carbonate, N,N-dimethylformamide, N,N-dimethylacetamide, N-methylpyrrolidone, N-ethylpyrrolidone, methylal, ethylal, butylal, 1,3-dioxolane, glycerol formal, benzene, toluene, n-hexane, cyclohexane, solvent naphtha and 2-methoxypropyl acetate (MPA). The solvents can moreover also carry groups which are reactive towards isocyanate groups. Examples of such reactive solvents are those which have an average functionality of groups which are reactive towards isocyanates of at least 1.8. These can be, for example, low molecular weight diols (e.g. 1,2-ethanediol, 1,3- and 1,2-propanediol, 1,4-butanediol), triols (e.g. glycerol, trimethylolpropane), but also low molecular weight diamines, such as, for example, polyaspartic acid esters.

The polyether-amines which can be employed as component (b) are, in particular, diamines or triamines. Such compounds are marketed, for example, by Huntsman under the name Jeffamine® or by BASF as polyether-amines.

Short-chain polyols or polyamines are usually employed as a crosslinker component or chain extender. Typical chain lengtheners are diethyltoluenediamine (DETDA), 4,4′-methylenebis-(2,6-diethyl)-aniline (MDEA), 4,4′-methylenebis-(2,6-diisopropyl)-aniline (MDIPA), 4,4′-methylene-bis-(3-chloro-2,6-diethyl)-aniline (MCDEA), dimethylthiotoluenediamine (DMTDA, Ethacure® 300), N,N′-di(sec-butyl)-amino-biphenylmethane (DBMDA, Unilink® 4200) or N,N′-di-sec-butyl-p-phenylenediamine (Unilink® 4100), 3,3′-dichloro-4,4′-diamino-diphenylmethane (MBOCA) and trimethylene glycol di-p-aminobenzoate (Polacure 740M). Aliphatic aminic chain extenders can likewise be employed or co-used: 1,3-propanediol, 1,4-butanediol, 2,3-butanediol, 1,5-pentanediol, 1,6-hexanediol and HQEE (hydroquinone di(β-hydroxyethyl)ether).

The process for the preparation of the polyisocyanate polyaddition products can be carried out in the presence of conventional rheology improvers, stabilizers, UV stabilizers, catalysts, hydrolysis stabilizers, emulsifiers, fillers, dyestuffs which can optionally be incorporated (that is to say which have Zerewitinoff-active hydrogen atoms) and/or coloured pigments. An addition of zeolites is also preferred.

Preferred auxiliary substances and additives are blowing agents, fillers, chalk, carbon black or zeolites, flame retardants, coloured pastes, water, microbicides, flow improvers, thixotropy agents, surface-modifying agents and retardants in the preparation of the polyisocyanate polyaddition products. Further auxiliary substances and additives include defoamers, emulsifiers, foam stabilizers and cell regulators. An overview is contained in G. Oertel, Polyurethane Handbook, 2nd edition, Carl Hanser Verlag, Munich, 1994, chap. 3.4.

Typical foaming agents are fluorohydrocarbons, pentane, cyclopentane, water and/or carbon dioxide.

The latent catalysts can be employed for the preparation of polyisocyanate polyaddition products, flexible and rigid foams, coatings, adhesives and sealants, semi-rigid foams, integral foams, spray and cast elastomers, resins and binders in polyurethane chemistry, and of thermoplastic polyurethanes.

The catalysts according to the invention can moreover be employed for the preparation of silicones and polyesters.

The invention is to be explained in more detail with the aid of the following examples.

### EXAMPLES

The catalysts according to the invention employed were:

Catalyst 1: (i-PrO)₂Ti(OCH₂CH₂)₂NCH₃

Preparation in accordance with instructions in the literature: Zaitsev, K. V.; Karlov, S. S.; Selina, A. A.; Oprunenko, Y. F.; Churakov, A. V.; Neumüller, B.; Howard, J. A. K.; Zaitseva, G. S. Eur. J. Inorg. Chem. 2006, 1987.

Catalyst 2: Ti[(OCH₂CH₂)₂NCH₃]₂

Preparation in accordance with instructions in the literature: Kemmitt, T.; Al-Salim, N. I.; Gainsford, G. J.; Henderson, W. Aust. J. Chem. 1999, 52, 915.

Definition of gel time (pot life) and demolding time in the preparation of polyurethane (PU):

The gel time is that time after which the PU reaction mixture changes in its flow properties on the basis of a noticeable increase in viscosity, when pouring it on to a flat steel sheet.

The demolding time is that time after which the PU test specimen can be pressed manually out of the steel cylinder without deformation.

### Example 1

### PU Preparation with Catalyst 1

280 g of Desmodur® MS 192 (MDI prepolymer from Bayer MaterialScience AG, 19.2% NCO content) were mixed with 470 g of Baytec® VP.PU 20GE12 (polyol from Bayer MaterialScience AG, OH number: 64 mg KOH/g), 30 g of 1,4-butanediol and 0.004 g (0.00051 wt. %) of catalyst 1 at 50° C. in a 1.5 1 tin can (diameter: 120 mm, height: 135 mm). The mixture was poured into a hollow steel cylinder (diameter: 40 mm, height: 80 mm) temperature-controlled at 80° C. and provided with a release agent (Indrosil 2000). The test specimen was removed from the cylinder.

### Example 2

### PU Preparation with Catalyst 2

280 g of Desmodur® MS 192 (MDI prepolymer from Bayer MaterialScience AG, 19.2% NCO content) were mixed with 470 g of Baytec® VP.PU 20GE12 (polyol from Bayer MaterialScience AG, OH number: 64 mg KOH/g), 30 g of 1,4-butanediol and 0.003 g (0.00038 wt. %) of catalyst 2 at 50° C. in a 1.5 1 tin can (diameter: 120 mm, height: 135 mm). The mixture was poured into a hollow steel cylinder (diameter: 40 mm, height: 80 mm) temperature-controlled at 80° C. and provided with a release agent (Indrosil 2000). The test specimen was removed from the cylinder.

### Comparison Example 3

### With Snapcure 2120 (Johnson Matthey Catalysts) as the Catalyst

280 g of Desmodur® MS 192 (MDI prepolymer from Bayer MaterialScience AG, 19.2% NCO content) were mixed with 470 g of Baytec® VP.PU 20GE12 (polyol from Bayer MaterialScience AG, OH number: 64 mg KOH/g), 30 g of 1,4-butanediol and 0.5 g (0.064 wt. %) of Snapcure 2120 at 50° C. in a 1.5 1 tin can (diameter: 120 mm, height: 135 mm). The mixture was poured into a hollow steel cylinder (diameter: 40 mm, height: 80 mm) temperature-controlled at 80° C. and provided with a release agent (Indrosil 2000). The test specimen was removed from the cylinder.

### Comparison Example 4

### With Snapcure 2130 (Johnson Matthey Catalysts) as the Catalyst

280 g of Desmodur® MS 192 (MDI prepolymer from Bayer MaterialScience AG, 19.2% NCO content) were mixed with 470 g of Baytec® VP.PU 20GE12 (polyol from Bayer MaterialScience AG, OH number: 64 mg KOH/g), 30 g of 1,4-butanediol and 0.5 g (0.064 wt. %) of Snapcure 2130 at 50° C. in a 1.5 1 tin can (diameter: 120 mm, height: 135 mm). The mixture was poured into a hollow steel cylinder (diameter: 40 mm, height: 80 mm) temperature-controlled at 80° C. and provided with a release agent (Indrosil 2000). The test specimen was removed from the cylinder.

### Comparison Example 5

### With Snapcure 2210 (Johnson Matthey Catalysts) as the Catalyst

280 g of Desmodur® MS 192 (MDI prepolymer from Bayer MaterialScience AG, 19.2% NCO content) were mixed with 470 g of Baytec® VP.PU 20GE12 (polyol from Bayer MaterialScience AG, OH number: 64 mg KOH/g), 30 g of 1,4-butanediol and 0.1 g (0.0128 wt. %) of Snapcure 2210 at 50° C. in a 1.5 1 tin can (diameter: 120 mm, height: 135 mm). The mixture was poured into a hollow steel cylinder (diameter: 40 mm, height: 80 mm) temperature-controlled at 80° C. and provided with a release agent (Indrosil 2000). The test specimen was removed from the cylinder.

### Comparison Example 6

### With Snapcure 2220 (Johnson Matthey Catalysts) as the Catalyst

280 g of Desmodur® MS 192 (MDI prepolymer from Bayer MaterialScience AG, 19.2% NCO content) were mixed with 470 g of Baytec® VP.PU 20GE12 (polyol from Bayer MaterialScience AG, OH number: 64 mg KOH/g), 30 g of 1,4-butanediol and 0.1 g (0.0128 wt. %) of Snapcure 2220 at 50° C. in a 1.5 1 tin can (diameter: 120 mm, height: 135 mm). The mixture was poured into a hollow steel cylinder (diameter: 40 mm, height: 80 mm) temperature-controlled at 80° C. and provided with a release agent (Indrosil 2000). The test specimen was removed from the cylinder.

### Comparison Example 7

### With Thorcat 535 (80% phenyl-Hg neodecanoate, 20% neodecanoic acid; Thor Especialidades S.A.) as the Catalyst

280 g of Desmodur® MS 192 (MDI prepolymer from Bayer MaterialScience AG, 19.2% NCO) were mixed with 470 g of Baytec® VP.PU 20GE12 (polyol from Bayer MaterialScience AG, OH number: 64 mg KOH/g), 30 g of 1,4-butanediol and 0.3 g (0.038 wt. %) of Thorcat 535 at 50° C. in a 1.5 1 tin can (diameter: 120 mm, height: 135 mm). The mixture was poured into a hollow steel cylinder (diameter: 40 mm, height: 80 mm) temperature-controlled at 80° C. and provided with a release agent (Indrosil 2000). The test specimen was removed from the cylinder.

### Comparison Example 8

### With 1,4-diazabicyclo[2.2.2]octane (DABCO) as the Catalyst

280 g of Desmodur MS 192 (MDI prepolymer from Bayer MaterialScience AG, 19.2% NCO) were mixed with 470 g of Baytec® VP.PU 20GE12 (polyol from Bayer MaterialScience AG, OH number: 64 mg KOH/g), 30 g of 1,4-butanediol and 0.024 g (0.003 wt. %) of DABCO at 50° C. in a 1.5 1 tin can (diameter: 120 mm, height: 135 mm). The mixture was poured into a hollow steel cylinder (diameter: 40 mm, height: 80 mm) temperature-controlled at 80° C. and provided with a release agent (Indrosil 2000). The test specimen was removed from the cylinder.

### Comparison Example 9

### With DBTL (dibutyltin dilaurate) as the Catalyst

280 g of Desmodur MS 192 (MDI prepolymer from Bayer MaterialScience AG, 19.2% NCO) were mixed with 470 g of Baytec® VP.PU 20GE12 (polyol from Bayer MaterialScience AG, OH number: 64 mg KOH/g), 30 g of 1,4-butanediol and 0.03 g (0.0038 wt. %) of DBTL at 50° C. in a 1.5 1 tin can (diameter: 120 mm, height: 135 mm). The mixture was poured into a hollow steel cylinder (diameter: 40 mm, height: 80 mm) temperature-controlled at 80° C. and provided with a release agent (Indrosil 2000). The test specimen was removed from the cylinder.

### Comparison example 10

### With DABCO DC-2 (Air Products Chemicals Europe B.V.) as the Catalyst

280 g of Desmodur MS 192 (MDI prepolymer from Bayer MaterialScience AG, 19.2% NCO) were mixed with 470 g of Baytec® VP.PU 20GE12 (polyol from Bayer MaterialScience AG, OH number: 64 mg KOH/g), 30 g of 1,4-butanediol and 0.015 g (0.0019 wt. %) of DABCO DC-2 at 50° C. in a 1.5 1 tin can (diameter: 120 mm, height: 135 mm). The mixture was poured into a hollow steel cylinder (diameter: 40 mm, height: 80 mm) temperature-controlled at 80° C. and provided with a release agent (Indrosil 2000). The test specimen was removed from the cylinder.

TABLE 1

| | Catalyst | Gel time | Demolding | Shore A |
|---|---|---|---|---|
| Catalyst | [wt. %] | [s] | [min] | hardness |
| Example 1 | 0.00051 | 240 | 27 | 74 |
| Example 2 | 0.00038 | 260 | 32 | 74 |
| Comparison 3 | 0.064 | 250 | 37 | 74 |
| Comparison 4 | 0.064 | 260 | 40 | 74 |
| Comparison 5 | 0.0128 | 240 | 36 | 74 |
| Comparison 6 | 0.0128 | 250 | 35 | 74 |
| Comparison 7 | 0.038 | 240 | 18 | 73 |
| Comparison 8 | 0.003 | 260 | 90 | 72 |
| Comparison 9 | 0.0038 | 240 | 100 | 73 |
| Comparison 10 | 0.0019 | 250 | 100 | 72 |

The hardness was measured in accordance with DIN 53505 after 72 h at room temperature.

Catalysts based on mixtures of a titanium compound and an amine were employed in Comparison Examples 3-6. A usual and conventional mercury catalyst was employed in Comparison Example 7, a typical catalyst based on a tertiary amine was employed in Comparison Example 8, a typical tin(IV) catalyst was employed in Comparison Example 9 and a tin(IV) catalyst with DABCO ligands was employed in Comparison 10.

Comparison Examples 8-10 demonstrate the non-existent thermolatency of a common tertiary amine, a typical tin(IV) catalyst and a catalyst mixture of an amine and a tin(IV) compound. It can furthermore be seen from the data in Table 1 that with about the same gel times in Examples 1 and 2 according to the invention, demolding times were obtained which were somewhat longer than that achieved with the established mercury catalyst (Comparison Example 7). However, the mercury catalyst has the great disadvantage of high toxicity. Compared with the catalysts based on mixtures of a titanium compound and an amine in Comparison Examples 3-6, the demolding times obtained with the catalysts according to the invention are significantly shorter. Furthermore, the catalysts according to the invention have the advantage over the mixtures of a titanium compound and an amine in Comparison Examples 3-6 that they can be employed universally without co-catalysts, and therefore different mixtures of titanium compound and co-catalyst for different uses are also not necessary. Compared with the class of tin catalysts (Comparison Examples 9 and 10) which is important for polyurethane preparation, the catalysts according to the invention quite generally have the immense advantage of higher activity, regardless of the latency. The catalysts according to the invention can therefore be employed in a considerably lower concentration compared with tin catalysts, which is accompanied by a significant economic advantage.

1.-4. (canceled)

5. A polyisocyanate polyaddition product with good mechanical properties, obtained from
a) a polyisocyanate and
b) a NCO-reactive compound
in the presence of
c) a latent catalyst
d) optionally further catalysts and/or activators which differ from c)
with the addition of
e) optionally blowing agents
f) optionally fillers and/or fibre materials
g) optionally auxiliary substances and/or additives,
wherein the latent catalyst c) comprises tetravalent mononuclear titanium, zirconium and/or hafnium compounds of the formula I having at least one ligand which is bonded via at least two oxygen or sulfur atoms and contains a single nitrogen atom
Me(IV)(L¹)ₙ₁(L²)ₙ₂(L³)ₙ₃ (I)
wherein n1 is 1 or 2, n2 and n3 are 0 or 1, Me represents Ti, Zr or Hf and L¹ represents a di-, tri- or tetravalent ligand and L², L³ represent mono- or divalent ligands
or tetravalent polynuclear titanium, zirconium and/or hafnium compounds based thereon, wherein at least one ligand per Me atom has the following meaning:
—X—Y
wherein
X represents O, S, OC(O), OC(S), O(O)S(O)O, O(O)S(O)
Y represents —R1-N(R2)(R3) or —R1-C(R4)=NR2
wherein R1, R2, R3, R4 independently of each other represent saturated or unsaturated, cyclic or acyclic, branched or unbranched, substituted or unsubstituted hydrocarbon moieties which optionally contain hetero atoms, or R2, R3, R4 independently of each other represent hydrogen, R1-X, or R2 and R3 or R2 and R1 or R3 and R1 or R4 and R1 or R4 and R2 form a ring
and —X—Y is bonded to an Me atom by at least two oxygen or sulfur atoms
and wherein the remaining ligands independently of each other represent —X—Y with the abovementioned meaning or have the following meaning:
halides, hydroxide, amide moieties, oxygen, sulfur or XR2.

6. A process for the preparation of the polyisocyanate polyaddition product according to claim 5, wherein said process comprises:
reacting polyisocyanates (a) with NCO-reactive compounds (b) in the presence of latent catalysts (c) and optionally additional catalysts and/or activators which differ from (c), with the addition of optionally blowing agents, optionally fillers and/or fibre materials and optionally auxiliary substances and/or additives, wherein the latent catalysts c) comprises tetravalent mononuclear titanium, zirconium and/or hafnium compounds of the formula I having at least one ligand which is bonded via at least two oxygen or sulfur atoms and contains a single nitrogen atom
Me(IV)(L¹)ₙ₁(L²)ₙ₂(L³)ₙ₃ (I)
wherein n1 is 1 or 2, n2 and n3 are 0 or 1, Me represents Ti, Zr or Hf and L¹ represents a di-, tri- or tetravalent ligand and L², L³ represent mono- or divalent ligands
or tetravalent polynuclear titanium, zirconium and/or hafnium compounds, wherein at least one ligand per Me atom has the following meaning:
—X—Y
Wherein
X represents O, S, OC(O), OC(S), O(O)S(O)O, O(O)S(O)
Y represents —R1-N(R2)(R3) or —R1-C(R4)=NR2
wherein R1, R2, R3, R4 independently of each other represent saturated or unsaturated, cyclic or acyclic, branched or unbranched, substituted or unsubstituted hydrocarbon moieties which optionally contain hetero atoms, or R2, R3, R4 independently of each other represent hydrogen, R1-X, or R2 and R3 or R2 and R1 or R3 and R1 or R4 and R1 or R4 and R2 form a ring and —X—Y is bonded to an Me atom by at least two oxygen or sulfur atoms and wherein the remaining ligands independently of each other represent —X—Y with the abovementioned meaning or have the following meaning:
halides, hydroxide, amide moieties, oxygen, sulfur or XR2.

7. A latent catalyst comprising tetravalent mononuclear titanium, zirconium, and/or hafnium compounds of the formula I having at least one ligand which is bonded via at least two oxygen or sulfur atoms and contains a single nitrogen atom, or di- or polynuclear tetravalent titanium, zirconium and/or hafnium compounds of the formulae II, III or IV having at least one ligand per metal (Me) atom which is bonded via at least two oxygen or sulfur atoms and contains a single nitrogen atom
Me(IV)(L¹)ₙ₁(L²)ₙ₂(L³)ₙ₃ (I)
wherein n1 is 1 or 2 and n2 and n3 are 0 or 1, Me represents Ti, Zr or Hf and L′ represents a di-, tri- or tetravalent ligand and L², L³ represent mono- or divalent ligands
[(L¹)ₙ₁(L²)ₙ₂Me(IV)]₂O (II)
wherein n1 is 1 and n2 is 0 or 1, Me represents Ti, Zr or Hf and L¹ represents a di- or trivalent ligand and L² represents a monovalent ligand
[(L¹)ₙ₁Me(IV)O]ₙ (III)
[(L¹)ₙ₁Me(IV)S]ₙ (IV)
wherein n1 is 1, n is greater than or equal to 2, Me represents Ti, Zr or Hf and L¹ represents a divalent ligand,
wherein at least one ligand per Me atom has the following meaning:
—X—Y
Wherein
X represents O, S, OC(O), OC(S), O(O)S(O)O, O(O)S(O)
Y represents —R1-N(R2)(R3) or —R1-C(R4)=NR2
R1, R2, R3, R4 independently of each other represent saturated or unsaturated, cyclic or acyclic, branched or unbranched, substituted or unsubstituted hydrocarbon moieties which optionally contain hetero atoms, or R2, R3, R4 independently of each other represent hydrogen, R1-X, or R2 and R3 or R2 and R1 or R3 and R1 or R4 and R1 or R4 and R2 form a ring
and —X—Y is bonded to an Me atom by at least two oxygen or sulfur atoms
and wherein the remaining ligands independently of each other represent —X—Y with the abovementioned meaning or have the following meaning:
halides, hydroxide, amide moieties, oxygen, sulfur or XR2.
